(19) United States
(12) Patent Application Publication
(10) Pub. No.: US 2010/0223798 A1
(43) Pub. Date: Sep. 9, 2010

(54) UNIQUE NUMBERING SYSTEM FOR RULERS, SQUARES AND TOOLS FOR BOTH RIGHT AND LEFT HANDED USERS

(76) Inventor: Darlene Zimmerman, Fairfax, MN (US)

Correspondence Address: MICHAEL RIES, 318 PARKER PLACE, OSWEGO, IL, 60543, US

(21) Appl. No.: 12/617,744

(22) Filed: Nov. 13, 2009

Related U.S. Application Data
(60) Provisional application No. 61/114,138, filed on Nov. 13, 2008.

(51) Int. Cl. G01B 3/02; B43L 7/00

(52) U.S. Cl. 33/494; 33/563

(57) ABSTRACT

A measuring device of transparent material has a first set of numbers of uniformly increasing values from right to left with a beginning at the right and an end at the left. The numbers are aligned with lines marked at an edge of the material with inch and increment of inch spacing. The right end of the first set of numbers are located at least one-quarter of an inch from the right edge of the material. A second set of numbers of uniformly increasing values from left to right has a beginning at the left and an end at the right are aligned with the lines marked at the top edge of the material with inch and increment of inch spacing. The left end of the second set of numbers are located at least one-quarter of an inch from the left edge of the material.

### REFERENCE TO RELATED APPLICATION

This patent application claims the benefit of U.S. Provisional Application No. 61114138 filed on 13 Nov. 2008, the disclosure of which is incorporated herein by reference in its entirety.

### BACKGROUND OF THE INVENTION

1. Field of the Invention

This invention relates to measuring devices for use by hobbyists and crafts people, and more particularly to a measuring device that has distinctive markings for both left and right handed persons.

2. Description of Related Art

Transparent measuring devices are useful for measuring, marking and cutting pattern such as quilt patterns and measuring a distance between two points by both right and left handed users.

Straight rulers, such as prior art yard stick 11 shown in FIG. 1 is an example of a measuring device used by quilters and craft persons where the measuring device has numbers imprinted thereon which correspond to inches and divisions of inches.

Measuring devices that include two sets of numbers which are marked in upside-down orientation relative to each other located along opposed lengthwise edges of the device where each set of numbers start at the same end of the measuring device are available for right and left handed users. A prior art measuring device having two sets of numbers as described above is shown in FIG. 2.

With the prior art ruler shown in FIG. 2, a right handed user will measure a distance between a first point or line and a second point or line by placing the end 2 of the measuring device at the first point or line and reading the number on the ruler at the second point or line to measure the distance between the two points. But, for a left handed user to read the measurement right-side-up, the ruler must first be turned upside down and first end 2 of the measuring device is placed to the left of the point or line from which the user is measuring.

If the end 2 of the measuring device is positioned for the user to measure from right to left, said user will need to twist the ruler upside down and therein read the numbers on the ruler upside down as well.

### SUMMARY OF THE INVENTION

It is an object of the present invention to provide an improved ruler in which the above disadvantages are substantially obviated.

It is another object of the present invention to provide a measuring device which can be used to measure a distance between two points or lines without having to read an aligned set of uniformly increasing numbers that are upside-down.

It is a further object of the present invention to provide a measuring device that has two sets of uniformly increasing measurement numbers where each set of numbers are readable right-side-up whether a measurement is from right to left, e.g., when the first point from which a user is measuring is located to the right of that point, or whether a user is measuring from left to right, e.g., when the point from which a user is measuring is located to the left of the point.

The measuring device here disclosed can be used to measure a distance from a first point to a second point where one end of the ruler is a reference end for one of two separate scales and the opposing end of the ruler is a reference end for the other scale.

The ruler is made of flat transparent material where one end is a reference end for a first set of numbers in ascending order; and the opposite end is a reference end for a second set of numbers in ascending order. Thus, the flat transparent material has two sets of numbers which are in inches and increments of inches where one set of numbers increase in value when read from left to right, and the second set of numbers, that are also printed along the same edge of the transparent material increases in value when read from right to left. Each of the two sets of numbers are in an upright position whether measuring from right to left or from left to right and one set of numbers is located below the other.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a top plan view of a prior art yard stick having a single set of numbers where the set of numbers is in inches;

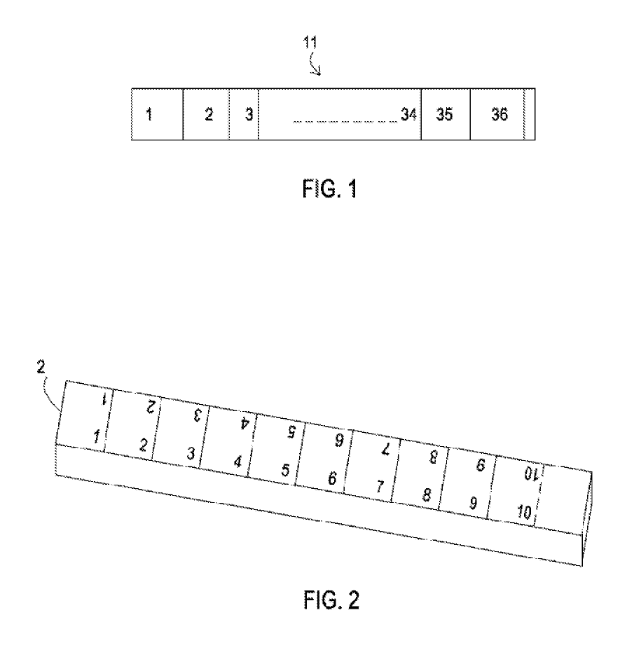

FIG. 2 is a top plan view of a prior art ruler having two sets of numbers where each set is in inches;

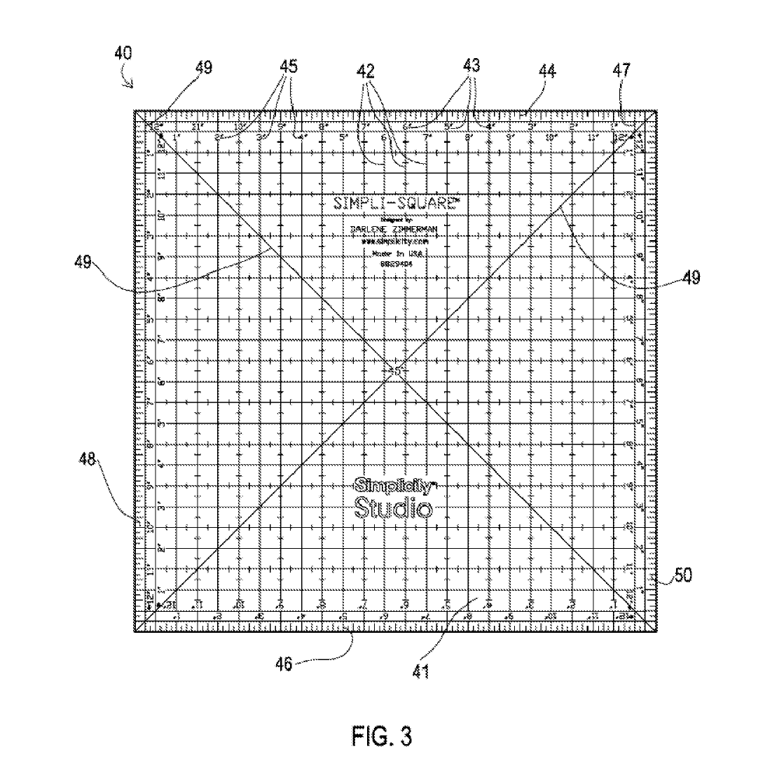

FIG. 3 is a top plan view of a square ruler having, at each edge, a first set of numbers which can be in one color and reads from right to left in ascending order for use by a right handed user and a second set of numbers located below the first set of numbers and which can be in a different color reads from left to right in ascending order for use by a left handed user where, regardless of which edge of the square is at the top, the numbers are always right side up in accordance with the principles of the invention;

FIG. 4 is a top plan view of a rectangular ruler having, at each edge, a first set of numbers which can be in one color and increases in value from right to left where the numbering starts at one inch from the edge of the ruler for use by a right handed user and a second set of numbers located below the first set of numbers and which can be in a different color with numbers of increasing value from left to right where the numbering starts at one inch from the edge of the ruler for use by a left handed user and, regardless of which edge of the rectangular ruler is at the top, the first and second sets of numbers at that edge will be right side up in accordance with the principles of the invention;

FIG. 5 is a top plan view of a square ruler having, at each edge, a first set of numbers which can be in one color and reads from right to left in ascending order where the numbering starts at a distance of one inch from the edge of the ruler and ends at the opposite end of the ruler for use by a right handed user and a second set of numbers located below the first set of numbers and which can be in a different color reads from left to right in ascending order where the numbering starts at a distance of one inch from the edge of the ruler and ends at the opposite edge for use by a left handed user, where, regardless of which edge of the rectangular ruler is at the top, the numbers of the first and second sets are always right side up in accordance with the principles of the invention; and

FIG. 6 is a top plan view of a rectangular ruler having, at each edge, a first set of numbers which can be in one color and reads from right to left in ascending order where the numbering starts at a distance of one inch from the edge of the ruler and ends at the opposite end for use by a right handed user and a second set of numbers located below the first set of numbers and which can be in a different color reads from left to right in ascending order where the numbering starts at a distance of one inch from the edge of the ruler and ends at the opposite end of the ruler for use by a left handed user where, regardless of which edge of the rectangular ruler is at the top, the numbers of the first and second sets are right side up in accordance with the principles of the invention.

### DETAILED DESCRIPTION OF THE INVENTION

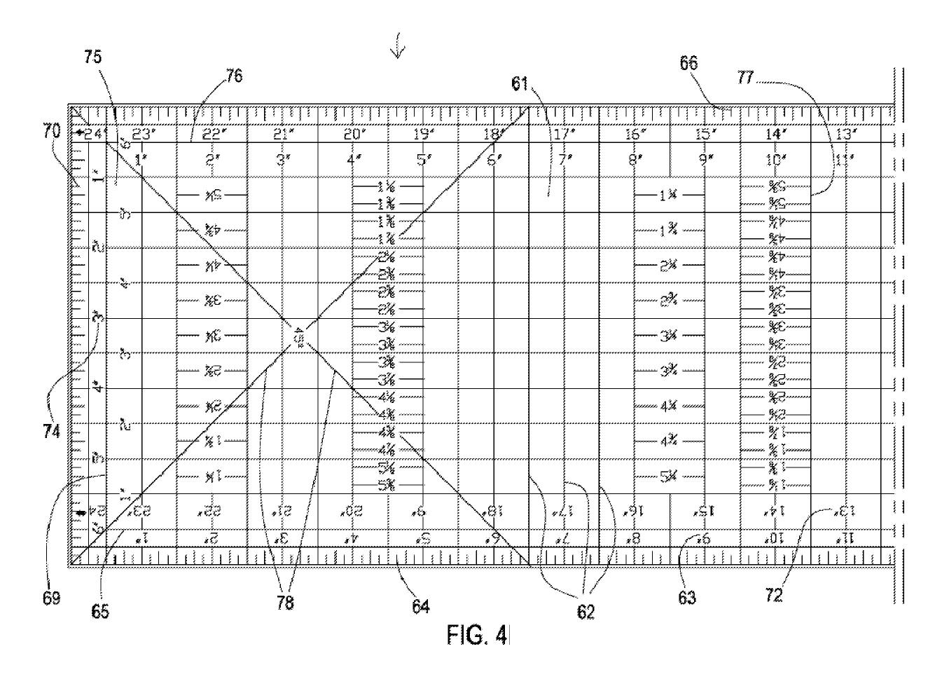

Referring to FIG. 3, there is shown a top plan view of a square ruler having, at each edge, a first set of numbers which can be in one color and reads from right to left in ascending order for use by a right handed user and a second set of numbers located below the first set of numbers and which can be in a different color that reads from left to right in ascending order for use by a left-handed user. Regardless of which edge of the square is at the top, the numbers at the top will be right side up.

Square measuring device 40 is a sheet of transparent material formed of any suitable transparent material such as acrylic plastic. The sheet of acrylic plastic can be substantially 3 MM thick having front surface 41, a rear surface, a top edge 44, a bottom edge 46, a left edge 48 and a right edge 50. The measuring device can have, in one embodiment, a length and width of 12½ inches. It is understood that the measuring device can be either smaller or larger.

Located along the top edge 44 of measuring device 40 is a plurality of inch and increment of inch lines that are perpendicular to the edge 44 and are of varying lengths. Long lines 42 designate half inch spacing where alternate long lines are marked with inch numbers 43. Quarter inch lines are located half way between the half inch long lines, and eighth inch lines are located between the quarter inch lines.

A first set of ruler numbers 43 at the top edge 44 start at line 47 that is one inch from the right edge 50 and end at the left edge 48. This first set is useful for a right handed user.

Long lines 42 continue down the measuring device to edge 46 which has a second set of numbers that are similar to the first set of numbers at edge 44.

Located immediately below the inch numbers 43 at edge 44 is a second set of inch numbers 45 that starts at line 49 that is one inch from edge 48 and extend to the edge 50. The second set of inch numbers 45 displaces one-half of an inch from the inch numbers 43 and has a color that is different than the color of the first set of inch markings 43. Inch markings 45 advance from left to right and are for a left handed user.

Long lines 42 that are aligned with the numbers of the second set continue down the measuring device to edge 46 which has a first set of numbers that are similar to the second set of numbers at edge 44.

The inch numbers 43, 45 at the top edge 44 are right side up when the measuring device is being used with the top edge at the top. The one-quarter inch lines on all the edges of the ruler allow the user to measure or add a one-quarter seam allowance.

The markings on the side edges 48 and 50 are similar to the markings on edges 44 and 46. Therefore, in the interest in brevity, the description of the inch markings at edges 48 and 50 will not be repeated.

The top surface 41 has a grid of vertical and horizontal lines that mark half and quarter inch locations and two lines 49 that mark 45 degrees.

The four sides of the measuring device 40 are identical and, therefore, regardless of how the measuring device is first placed on a work piece that is to be measured, the measuring device will be properly oriented with each set of numbers being right side up. A user will not have to turn the measuring device to find a specific edge. In addition, the measuring device can be easily used by right and left handed users.

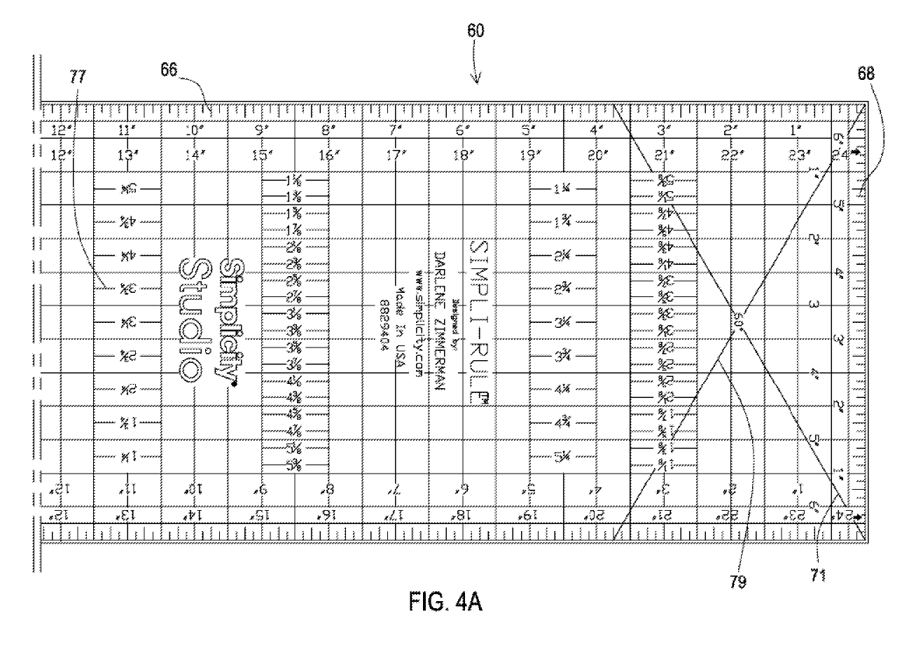

Referring to FIG. 4, there is shown a top plan view of a rectangular ruler having, at each edge, a first set of numbers which can be in one color and increases in value from right to left where the numbering starts at one inch from the edge of the ruler for use by a right handed user, and a second set of numbers located below the first set of numbers and which can be in a different color increases in value from left to right where the numbering starts at one inch from the edge of the ruler for use by a left handed user.

Rectangular measuring device 60 is a sheet of transparent material formed of any suitable transparent material such as acrylic plastic. The sheet of acrylic plastic can be substantially 3 MM thick and have a front surface 61, a rear surface, a top edge 64, a bottom edge 66, a left edge 68 and a right edge 70. The measuring device can have, in one embodiment, a length of 24 inches and a width of 6½ inches. It is understood that the measuring device can have a length and width that is either smaller or larger.

Located along the top edge 64 of measuring device 60 is a plurality of inch and increment of inch lines that are perpendicular to the edge 64 and are of varying lengths. Long lines 62 designate half inch spacing where alternate long lines are marked with inch numbers 63. Quarter inch lines located half way between the half inch long lines distances are marked with shorter lines, and eighth inch lines are marked with still shorter lines.

The ruler markings at the top edge 64 start at line 69 that is one-half of an inch from the right edge 70 and extend to line 71 that is one-half of an inch from the edge 68 and can be used by right handed users. The long lines 62 continue down the measuring device to edge 66 which has markings that are similar to the markings at edge 44.

Located immediately below the first set of inch numbers 63 is a second set of inch numbers 72 that start at line 71 and extend to line 69. The inch numbers 72 are aligned with inch numbers 63 at the first edge 54 and have a color that is different than the color of the inch markings 63. Inch markings 72 read from left to right and are for left handed users.

A line 62 that marks a number of the first set of numbers at edge 64 marks a number of a second set of numbers at the opposite edge 66, and a line 62 that marks a number of the second set of numbers at edge 64 marks a number of a first set of numbers at the opposite edge 66.

The inch numbers 63, 72 at the top edge 64 are right side up when either edge 64 or 66 of the measuring device is at the top. The one-quarter inch lines on all the edges of the ruler allow the user to measure or add a one-quarter seam allowance.

Looking at edge 70, a first set of numbers 74 starts at line 76 that is one-half of an inch from edge 66 and advances to edge 64. A second set of numbers 75 starts at line 65 that is one-half of an inch from edge 64 and advances to edge 66. The first set of numbers 74 read from right to left and are for a right handed user, and the second set of numbers 75 read from left to right and are for a left handed user. The one-quarter inch lines on all the edges of the ruler allow the user to measure or add a one-quarter seam allowance.

The first set of numbers at edge 70 is aligned with a second set of numbers at edge 68 and the second set of numbers 75 at edge 70 is aligned with a first set of numbers at edge 68.

Located on the front surface 61 are inch and increments of an inch numeral 77 that are color coded to correspond to the colors of inch markings 63 and 72 at the edges of the rule, and 45 degree angle lines 78, and 60 degree lines 79.

With measuring device 60, regardless of how it is first placed on a work piece that is to be measured, the measuring device will be properly oriented where the first and second set of numbers at the top edge will be right side up and can be read without requiring a user to twist or turn his/her head or the ruler. In addition, the measuring device can be easily used by either a right and left handed user.

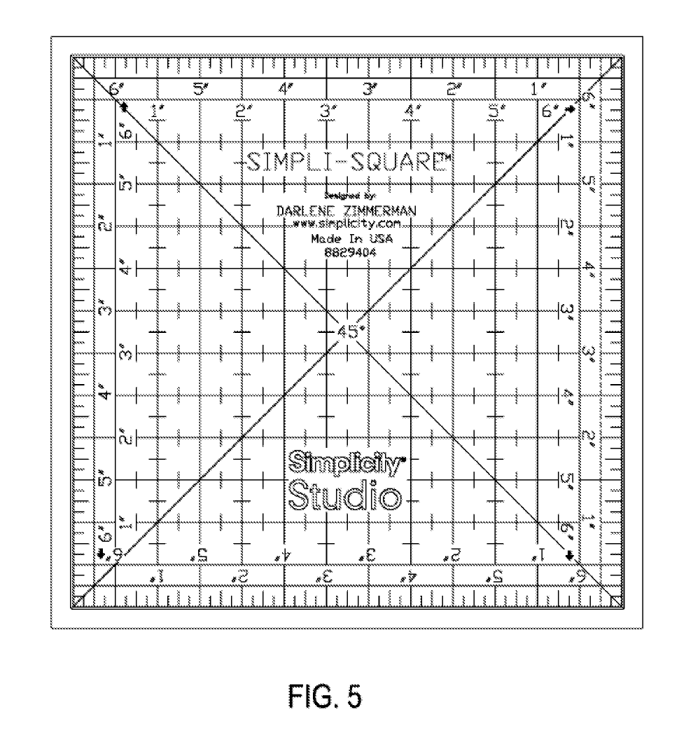

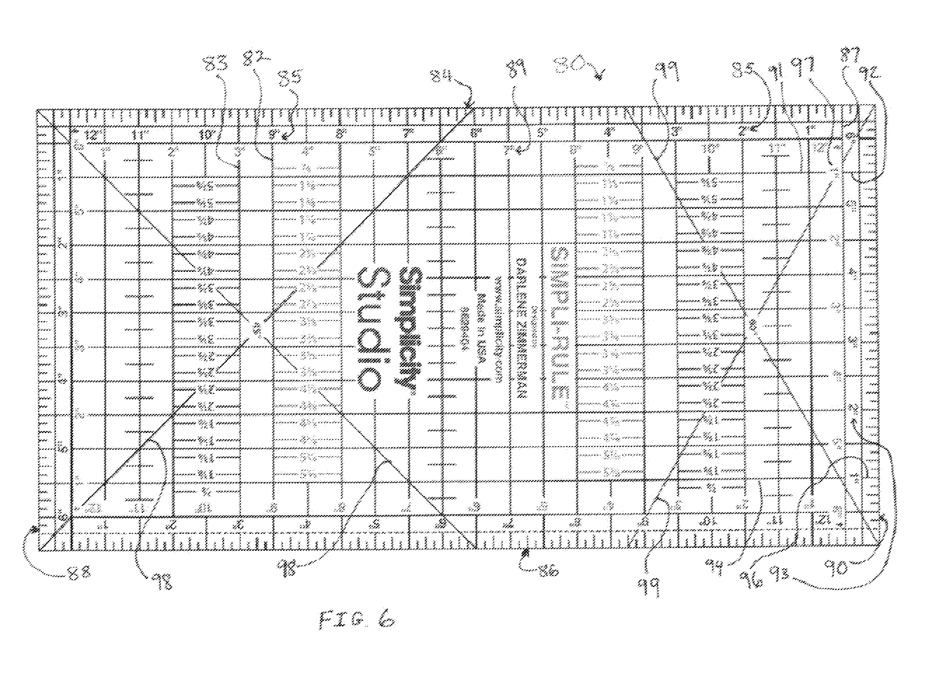

Referring to FIG. 5, there is shown a top plan view of a square ruler for measuring and cutting quilt patterns where the ruler has four edges where each edge has inch and increment of inch scale lines, and a first set of inch numbers which can be in one color that read from right to left for use by a right handed user and a second set of inch numbers located behind the first set of inch numbers which can be of a different color and reads from left to right for use by a left handed user. The numbers of the first and second sets are right side up, and the first set of inch numbers starts at a line that is one inch in from the edge of the ruler and ends at the opposite edge of the ruler. The second set of inch numbers starts at a line that is one inch in from the edge of the ruler and ends at the opposite edge of the ruler. The measuring device of FIG. 6 is six and one-half inches square and is a small version of the measuring device shown in FIG. 4 that is twelve and one-half inches square.

Referring to FIG. 6, there is shown a top plan view of a rectangular quilting ruler where each edge has inch and increment of inch scale lines, and a first set of inch numbers that starts one inch from the right edge and increases in value from right to left for use by a right handed user, and a second set of inch numbers that starts one inch from the left edge of the ruler, which can be of a different color than the first set, and increases in value from left to right for use by a left handed user. Each set of numbers at each edge of the ruler are right side up and, regardless of which edge of the ruler is at the top, the numbers at the top will always be right side up.

Rectangular measuring device 80 is a sheet of transparent material formed of any suitable transparent material such as acrylic plastic. The sheet of acrylic plastic can be substantially 3 MM thick and has a front surface 83, a rear surface, a top edge 84, a bottom edge 86, a left edge 88 and a right edge 90. The measuring device can have, in one embodiment, a length of 12½ inches and a width of 6½ inches. It is understood that the measuring device can have a length and width that is either smaller or larger.

Located along the top edge 84 of measuring device 80 is a plurality of inch and increment of inch lines that are perpendicular to the edge 84 and are of varying lengths. Long lines designate half inch spacing and alternate long lines are marked with inch numbers 85 of a first set of numbers. Quarter inch lines located half way between the half inch long lines distances are marked with shorter lines, and eighth inch lines are marked with still shorter lines.

The ruler markings at the top edge 84 start at line 87 that is one-half of an inch from the right edge 90, extends to the left edge 88. Alternating long lines 82, 83 continue down the measuring device to edge 86 which has markings that are similar to the markings at edge 84.

Located immediately below the first set of inch numbers 85 is a second set of inch numbers 89 that starts at line 91 and extends to the end 90 of the ruler. The second set of inch numbers 89 is displaced one-half of an inch from the first set of inch numbers 85 and has a color that is different than the color of the first set of inch markings 85. Inch markings 89 read from left to right.

Long lines 82 that are aligned with numerals of the first set at edge 84 are aligned with numerals of a second set located at edge 86 and long lines 83 that are aligned with numerals of the second set at edge 84 are aligned with numerals of the first set at the opposite edge 86.

The inch numbers 85, 89 at the top edge 84 are right side up when the measuring device is being used with the top edge of the ruler at the top. The one-quarter inch lines on all the edges of the ruler allow the user to measure or add a one-quarter seam allowance. The first set of numbers and the second set of numbers at the edge 84 are replicated at edge 86 of the ruler.

Side edge 90 displays long lines 92, 94 that designate inch and half inch spacing where alternate long lines are marked with inch numbers 93 of a first set of numbers that are aligned with long lines 94. Quarter inch lines located half way between the half inch long lines distances are marked with shorter lines and eighth inch lines are marked with still shorter lines.

The first set of inch markings 93 at the edge 90 starts at line 96 that is spaced one-half of an inch from the edge 86 and extends to edge 84. Located immediately below the first set of inch numbers 93 is a second set of inch numbers 97 that starts at line 91 that is one inch from end 84 and extend to the edge 86 of the ruler. The second set of inch numbers 89 has a color that is different than the color of the first set of inch markings 93 and reads from left to right.

Long lines 94 that are aligned with numerals of the first set at edge 90 are aligned with numerals of a second set located at edge 88 and long lines 92 that are aligned with numerals of the second set at edge 90 are aligned with numerals of the first set at the opposite edge 88.

The inch numbers 93, 97 at the edge 90 are right side up when this edge is being used for measuring and is at the top. The one-quarter inch lines on all the edges of the ruler allow the user to measure or add a one-quarter seam allowance. The first and second sets of numbers at edges 84, 90, are replicated at edges 86, 88 of the ruler.

The top surface 83 has a plurality of parallel lines that mark half and quarter inch locations and two 45 degree lines 98 and two 60 degree lines 99.

Regardless of how the measuring device is first placed on a work piece that is to be measured, the first and second set of numbers at the top of the ruler will be right side up. In addition, the measuring device can be easily used by both right and left handed users.

It is understood that lines and numbers can be placed on the back surface of the measuring device. When the lines are located on the back surface of the measuring device, error due to parallax will be avoided.

When a person is using the disclosed measuring device he/she can now allow for a seam of one-quarter measurement on any side of a pattern without lifting, turning or moving the measuring device. In addition, the measuring device can be easily used by a left or right handed user.

The measuring device is made of a material that resists cutting or being shaved by a cutting tool such as a straight edge or a rotary cutter having a circularly configured blade rotatably connected to a handle when the measuring device is used as a guide when cutting fabric.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A measuring device comprising:
a sheet of material;
a first set of numbers of uniformly increasing values that has a beginning and an end aligned with lines marked on the sheet with inch and increment of inch spacing;
wherein said first set of numbers begin at least one-quarter of an inch from an edge of said sheet of material and end at least one-quarter of an inch from an opposite end of said material

2. The measuring device of claim 1 wherein said first set of numbers begins one inch from the edge of said material.

3. The measuring device of claim 1 wherein said first set of numbers ends one-half of an inch from the edge of said material.

4. The measuring device of claim 2 wherein said first set of numbers ends one-half of an inch from the edge of said material.

5. The measuring device of claim 4 wherein said material is transparent.

6. A measuring device comprising:
a sheet of material having a top edge, a bottom edge, a right edge, and a left edge;
a first set of numbers of uniformly increasing values from right to left having a beginning at the right and an end at the left aligned with lines marked at the top edge of said sheet with inch and increment of inch spacing;
the right end of said first set of numbers located at least one-quarter of an inch from the right edge of said sheet of material;
a second set of numbers of uniformly increasing values from left to right having a beginning at the left and an end at the right aligned with the lines marked at the top edge of sad sheet with inch and increment of inch spacing; and
the left end of said second set of numbers located at least one-quarter of an inch from the left edge of said sheet of material.

7. The measuring device of claim 6 wherein the right end of said first set of numbers is located about one-half of an inch from the right edge of said sheet of material; and the left end of said first set of numbers is located about one-half of an inch from the right edge of said sheet of material.

8. The measuring device of claim 7 wherein each line for a number of said second set of numbers is aligned with a line half way between two adjacent numbers of said first set of numbers.

9. The measuring device of claim 8 wherein the numbers of said first and second sets are right side up when said sheet of material is oriented to have the top edge at the top.

10. The measuring device of claim 9 wherein the numbers of said first and second sets are different colors.

11. The measuring device of claim 9 wherein the sheet of material is transparent.

12. The measuring device of claim 6 further comprising:
a third set of numbers of uniformly increasing values from left to right having a beginning at the left and an end at the right aligned with lines marked at the bottom edge of sad sheet with inch and increment of inch spacing;
the left end of said third set of numbers located at least one-quarter of an inch from the left edge of said sheet of material;
a fourth set of numbers of uniformly increasing values from right to left having a beginning at the right and an end at the left aligned with the lines marked at the bottom edge of sad sheet with inch and increment of inch spacing; and
the right end of said second set of numbers located at least one-quarter of an inch from the right edge of said sheet of material.

13. The measuring device of claim 12 wherein the left end of said third set of numbers is located about one-half of an inch from the left edge of said sheet of material; and the right end of said first set of numbers is located about one-half of an inch from the left edge of said sheet of material.

14. The measuring device of claim 13 wherein each line for a number of said fourth set of numbers is aligned with a line half way between two adjacent numbers of said third set of numbers.

15. The measuring device of claim 14 wherein the numbers of said third and fourth sets are right side up when said sheet of material is oriented to have the bottom edge at the top.

16. The measuring device of claim 15 wherein the numbers of said first and third sets have the same colors.

17. The measuring device of claim 15 wherein the numbers of said first and third sets have the same colors and are different than the colors of the numbers of said second and fourth sets

18. The measuring device of claim 17 wherein the sheet of material is transparent.

19. The measuring device of claim 15 wherein the numbers of said fourth set of numbers are aligned with the numbers of said first set of numbers and the numbers of said third set of numbers are aligned with the numbers of said second set of numbers.

20. The measuring device of claim 12 wherein
the right end of said first set of numbers ends at the left edge of said sheet of material;
the left end of said second set of numbers end at the right edge of said sheet of material.
the left end of said third set of numbers ends at the right edge of said sheet of material; and
the right end of said second set of numbers ends at the left edge of said sheet of material.
